(19) United States
(12) Patent Application Publication
(10) Pub. No.: US 2015/0181936 A1
(43) Pub. Date: Jul. 2, 2015

(54) Apparatus for Heating Smokeable Material

(71) Applicant: British American Tobacco (Investments) Limited, London (GB)

(72) Inventors: Alex Lyubomirskiy, Stoughton, MA (US); Sergei Ikovenko, Boston, MA (US)

(73) Assignee: British American Tobacco (Investments) Limited, London (GB)

(21) Appl. No.: 14/142,547

(22) Filed: Dec. 27, 2013

(51) Int. Cl. A24F 47/00; H05B 3/10

(52) U.S. Cl. CPC A24F 47/008; H05B 3/10

(57) ABSTRACT

An apparatus is configured to heat smokeable material to volatilize at least one component of the smokeable material. The apparatus comprises a heater comprising a heat-shrink material. The heater is configured to progressively heat the smokeable material upon constriction of the heat-shrink material.

### TECHNICAL FIELD

The present invention relates to apparatus for heating smokeable material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are so-called heat-not-burn products which release compounds by heating, but not burning, the material. The material may be for example tobacco or other non-tobacco products, which may or may not contain nicotine.

### SUMMARY

According to the present invention, there is provided an apparatus configured to heat smokeable material to volatilize at least one component of the smokeable material, wherein the apparatus comprises a heater comprising a heat-shrink material, and wherein the heater is configured to progressively heat the smokeable material upon constriction of the heat-shrink material.

The heater may be configured to trigger constriction of the heat-shrink material.

The heater may be configured to trigger constriction of the heat-shrink material in response to a user action.

The heater may be configured to trigger constriction of the heat-shrink material by heating the heat-shrink material to a shrink temperature of the heat-shrink material.

The heater may comprise a heating element arranged to trigger constriction of the heat-shrink material by heating the heat-shrink material to the shrink temperature.

The heating element may be in contact with a first end of the heat-shrink material.

The heat-shrink material may comprise a plurality of sections of heat-shrink material and the heating element may be in contact with a first section of heat-shrink material.

The apparatus may be configured to trigger constriction of the heat-shrink material by causing an electrical current to pass through the heating element.

The apparatus may be configured to resistively heat the heating element to the shrink temperature of the heat-shrink material.

The heater may be configured to progressively constrict the heat-shrink material along the heater to cause progressive heating of the smokeable material.

The heater may be configured to provide an area of elevated temperature, which area is small in comparison to the total surface area of the heater assembly. For example, the region of elevated temperature may comprise less than 10%, less than 20%, or less than 40% of the total surface area of the heater.

The heater may be configured to cause the area of elevated temperature to migrate progressively from a first end of the heater to a second end.

The heater may comprise a plurality of electrical elements, and the heater may be configured to form an electrically resistive contact between the electrical elements upon constriction of a portion of the heat-shrink material.

The electrically resistive contact may be configured to supply heat to the smokeable material and also to cause constriction of a further portion of the heat-shrink material.

Prior to constriction of the heat-shrink material, the electrical elements may be electrically isolated from one another by the heat-shrink material.

The heater may be configured to alter the position and/or shape of one or more of the electrical elements by means of the constriction of the heat-shrink material.

The heater may be configured to form the electrically resistive contact between the electrical elements upon alteration of the position and/or shape of the one or more electrical elements.

The electrical elements may extend from a first end of the heater to a second end, and the heater may be configured to form the electrically resistive contact between the electrical elements at the first end of the heater.

The heater may be configured to cause the position of the electrically resistive contact to migrate progressively from the first end of the heater to a second end.

The heat-shrink material may comprise polyolefin, PTFE, or Viton.

The apparatus may be configured to heat the smokeable material without combusting the smokeable material.

### BRIEF DESCRIPTION OF THE FIGURES

Embodiments will now be described, by way of example only, with reference to the accompanying Figures, in which:

FIG. 1 is a perspective, partially cut-away illustration of an example of an apparatus configured to heat smokeable material, according to a first embodiment;

FIG. 2 is an exploded, partially cut-away view of the apparatus of FIG. 1;

FIG. 3A is a diagram illustrating the heater assembly shown in FIG. 1 prior to use;

FIG. 3B is a diagram illustrating the heater assembly shown in FIG. 1 in use at a first time point;

FIG. 3C is a diagram illustrating the heater assembly shown in FIG. 1 in use at a second time point which is later than the first time point;

FIG. 4A is a diagram illustrating a transverse cross-sectional view of the heater and smokeable material of the apparatus shown in FIG. 1;

FIG. 4B is a diagram illustrating a transverse cross-sectional view of an example of the heaters and smokeable material according to a second embodiment, comprising two heaters;

FIG. 4C is a diagram illustrating a transverse cross-sectional view of an example of the heaters and smokeable material according to a third embodiment, comprising three heaters;

FIG. 5A is a diagram illustrating a transverse cross-sectional view of an example of the heater assembly and smokeable material according to a fourth embodiment, prior to use;

FIG. 5B is a diagram illustrating a transverse cross-sectional view of the heater assembly and smokeable material of the fourth embodiment, after use;

FIG. 6A is a diagram illustrating a transverse cross-sectional view of an example of the heater assembly and smokeable material according to a fifth embodiment, prior to use;

FIG. 6B is a diagram illustrating a transverse cross-sectional view of the heater assembly and smokeable material the fifth embodiment, after use;

FIG. 7A is a diagram illustrating a longitudinal cross-sectional view of an example of the heater assembly according to a sixth embodiment, prior to use;

FIG. 7B is a diagram illustrating a longitudinal cross-sectional view of the heater assembly of the sixth embodiment, in use at a first time point; and

FIG. 7C is a diagram illustrating a longitudinal cross-sectional view of the heater assembly of the sixth embodiment, in use at a second time point which is later than the first time point.

### DETAILED DESCRIPTION

As used herein, the term “smokable material” includes materials that provide volatilized components upon heating, typically in the form of an aerosol. “Smokable material” includes any tobacco-containing material and may, for example, include one or more of tobacco, tobacco derivatives, expanded tobacco, reconstituted tobacco or tobacco substitutes. “Smokable material” also may include other, non-tobacco, products, which, depending on the product, may or may not contain nicotine.

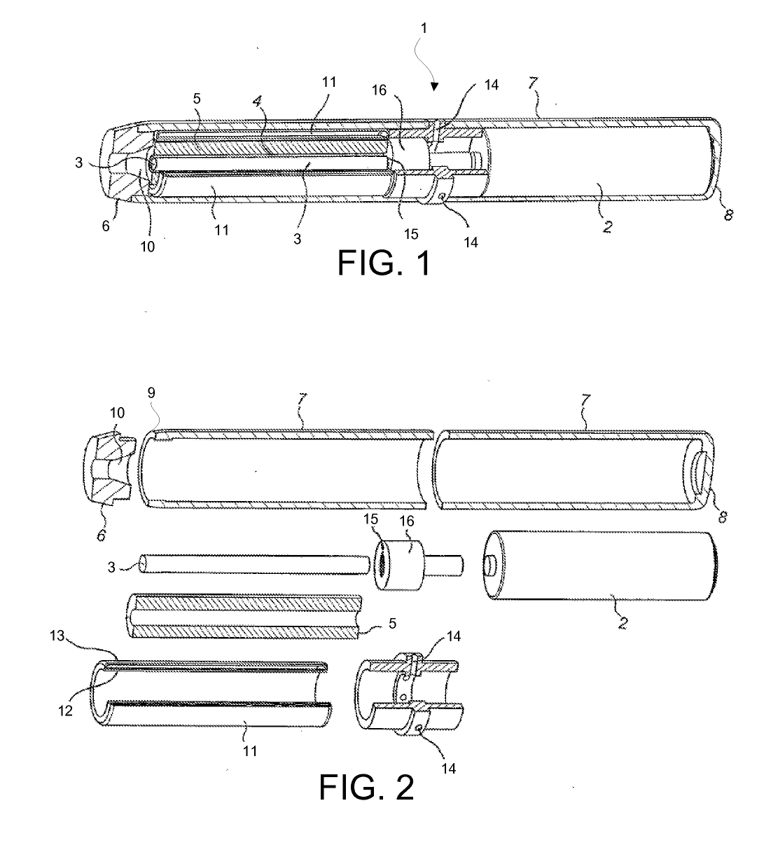

FIG. 1 shows an example of an apparatus for heating smokeable material according to a first embodiment.

As shown in FIG. 1, the apparatus 1 comprises an energy source 2, a heater 3, and a heating chamber 4, which contains smokeable material 5.

The energy source 2 of this example comprises a Li-ion battery. Any suitable type of energy source, such as a Ni battery, alkaline battery and/or the like, may alternatively be used. The energy source 2 may be rechargeable. The energy source 2 is electrically coupled to the heater 3 to supply electrical energy to the heater 3 when required.

The heating chamber 4 is configured to receive smokeable material 5 so that the smokeable material 5 can be heated in the heating chamber 4. The heater 3 and heating chamber 4 are arranged so that the heater 3 is able to heat the heating chamber 4. Generally, and in the embodiment shown in FIG. 1, the heating chamber 4 is located adjacent to the heater 3 so that thermal energy from the heater 3 heats the smokeable material 5 in the heating chamber 4. The heater 3 heats the heating chamber 4 sufficiently to volatilize aromatic compounds and nicotine if present in the smokeable material 5 without burning the smokeable material 5.

In the embodiment shown in FIG. 1, the heater 3 is in the form of a substantially cylindrical, elongate rod, which extends along part of a central longitudinal axis of the apparatus 1, towards the mouth end. The heating chamber 4 is located around the circumferential, longitudinal surface of the heater 3. The smokeable material 5 is in the form of a hollow, annular cylinder which fits within the heating chamber 4. The smokeable material 5 is located within the apparatus 1 such that the heater 3 is positioned within the central longitudinal cavity of the smokeable material 5. The smokeable material 5 thus fits closely around the heater 3 to ensure efficient heat transfer from the heater 3 to the smokeable material 5. The heating chamber 4 and smokeable material 5 therefore comprise co-axial layers around the heater 3. However, as will be evident from the discussion below, in other embodiments, other shapes and configurations of the heater 3, heating chamber 4, and smokeable material 5 can alternatively be used.

In the embodiment shown in FIG. 1, the smokeable material 5 comprises a tobacco blend, or some other volatisable material.

FIG. 2 is an exploded diagram of the apparatus shown in FIG. 1. As shown in FIG. 2, the apparatus 1 further comprises an annular mouthpiece 6 and a housing 7 in which the components of the apparatus 1 such as the energy source 2 and heater 3 are contained.

In the embodiment shown, the housing 7 comprises an approximately cylindrical tube with the energy source 2 located towards its first end 8, and the heater 3 and heating chamber 4 located towards its opposite, second end 9. As shown in FIG. 1, the energy source 2 and heater 3 are aligned along the central longitudinal axis of the housing 7.

The mouthpiece 6 attaches to the second end 9 of the housing 7, which may also be considered to be the mouth end of the apparatus 1. The mouthpiece 6 is located adjacent to the heating chamber 4 and smokeable material 5, such that the annular mouthpiece 6 provides a passageway 10 for fluid communication between the mouth of the user and the heating chamber 4.

Thermal insulation 11 is provided between the smokeable material 5 and the housing 7 to reduce heat loss from the apparatus 1 and therefore improve the efficiency with which the smokeable material 5 is heated. In the embodiment shown in FIGS. 1 and 2, a layer of thermal insulation 11, comprising a substantially tubular length of thermal insulation 11, is located co-axially around the heating chamber 4 and smokeable material 5.

As shown in FIG. 2, the layer of thermal insulation 11 in this example comprises vacuum insulation, and in particular in this example comprises a double-wall arrangement 12 enclosing an internal region 13. An example of a suitable material for the double wall arrangement 12 is stainless steel and an example of a suitable thickness for the walls of the double wall arrangement 12 is approximately 100 μm. The internal region or core 13 of the insulation 11 comprises a void. In other embodiments, the internal region 13 may include open-cell porous materials comprising, for example, polymers, aerogels or other suitable materials, which may be evacuated to a low pressure. The pressure in the internal region 13 is generally in the range of 0.1 to 0.001 mbar. The thermal conductivity of the thermal insulation 11 is generally in the range of 0.004 to 0.005 W/mK.

A reflective coating may be applied to the internal surfaces of the double wall arrangement 12 to further reduce heat losses through the thermal insulation 11. The coating may, for example, comprise an aluminium infrared (IR) reflective coating.

The apparatus 1 comprises air conduits 14, which allow external air to be drawn into the housing 7 and through the heating chamber 4 when the apparatus 1 is in use. The air conduits 14 comprise apertures 14 in the housing 7 which are located upstream from the smokeable material 5 and heating chamber 4 towards the first end 8 of the housing 7. The air conduits 14 may also allow any excess heat from the energy source 2 to be dissipated.

The heating chamber 4 may comprise inlet valves 15 which, when closed, prevent gaseous flow from the air conduits 14 into the heating chamber 4. The valves 15 can thereby reduce the diffusion of air and smokeable material flavours from the heating chamber 4, as discussed in more detail below. The valves 15 may be located within a cylindrical buffer 16 which is positioned at the end of the heating chamber 4 towards the first end 8 of the housing 7. More specifically, the cylindrical buffer 16 may be positioned to separate the energy source 2 and air conduits 14 on one side, from the heater 3, heating chamber 4, and smokeable material 5 on the other side of the cylindrical buffer 16. The buffer 16 provides heat insulation between the energy source 2 and the heater 3 to prevent direct transfer of heat from one to the other. The cylindrical buffer 16 also comprises an arrangement (not shown) for electrically coupling the heater 3 to the power source 2.

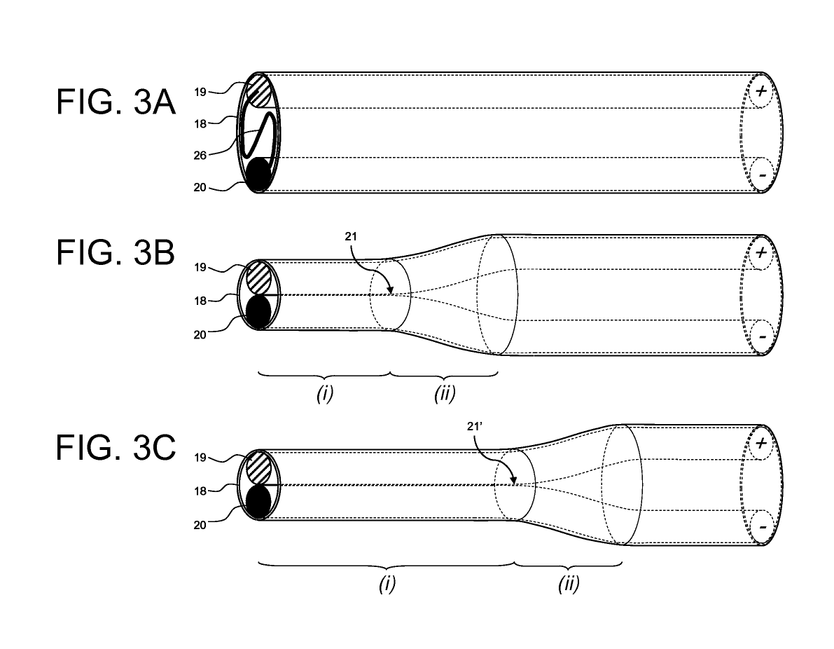

An example of the heater 3 is shown in detail in FIG. 3A. The heater 3 comprises a heat-shrink material 18, which in the example shown is a length of heat-shrink tubing 18. The heater 3 also comprises first and second electrical elements 19, 20. The elements 19, 20 are held within the heat-shrink tubing 18. In this embodiment, the elements 19, 20 are adhered to the inner wall of the heat-shrink tubing 18, located diametrically opposite to one another, by means of a thermoplastic adhesive. Prior to use of the apparatus 1, the elements 19, 20 are arranged within the heat-shrink tubing 18 such that they are electrically isolated from one another, although they may be electrically coupled by an ignition mechanism, such as a heater element, as described below.

Heat shrink material may also be referred to as “shrink film”, “shrink wrap”, “heat shrink” and “heat-shrink tubing”. As used herein, “shrink”, “shrinkage”, “constriction” and similar terms refer to the contraction and reduction in size of the shrink film 18. The shrink film 18 shrinks at a temperature herein referred to as the “shrink temperature”. The shrink temperature may be a similar temperature, or may be less than, the volatilization temperature of the smokeable material 5. Generally, the shrink temperature of suitable heat-shrink materials may be above 50° C., such as between 80° C. and 150° C. or between 90° C. and 130° C. Therefore, examples of shrink temperatures of suitable heat-shrink materials include 100° C. and 120° C.

Suitable heat shrink materials may vary in terms of, for example, thickness, clarity, strength and shrink ratio. The heat shrink material 18 may be thermally conductive, so that heat generated within the heater 3 may be efficiently conducted through the material 18. For this reason, it may be advantageous to use a heat shrink material 18 which is as thin as possible, such as for example, having a thickness of 10 μm to 200 μm, or 20 μm to 100 μm. For the same reason of improved heat conductance, it may additionally or alternatively be advantageous for the heat shrink material 18 to comprise a plurality of perforations.

The heat shrink material 18 may have sufficient strength such that when it shrinks it is capable of bending and/or adjusting the relative position of the elements 19, 20 without tearing or otherwise rupturing, as shown in FIG. 3B.

The shrink ratio of a heat shrink material is a measure of the capacity of the material to shrink, contract or constrict. The heat shrink material 18 has a shrink ratio that is sufficient such that upon shrinkage, the elements 19, 20 are moved from a relative position in which they are electrically isolated into a relative position in which they are in resistive contact. The shrink ratio may be up to about 4:1 and is preferably between about 3:1 and about 3:2, such as at or about 2:1.

Generally, heat shrink materials comprise polymers, and in particular, heat shrink materials may comprise a thermoplastic material comprising polyolefin, fluoropolymer (such as FEP, PTFE, or Kynar), PVDF, nylon, PVC, neoprene, polyethylene, silicone elastomer, Viton, or many other compositions. Generally, polyolefin, PTFE, and Viton may be used as suitable heat-shrink materials. Heat shrink materials may comprise a plurality of layers, comprising the same or different materials. The heat shrink material 18 used in the embodiment shown in FIGS. 1 to 3, comprises a perforated polyolefin material. Different heat-shrink materials may be used depending, for example, on the temperature of the heating zone, and the desired shrink temperature of the heat-shrink material.

Heat shrink materials which preferentially shrink circumferentially with respect to the heater 3 may be used. As a result, as shown in FIG. 3B, upon shrinkage of the heat-shrink tubing 18, the diameter and circumference of the tube 18 are reduced. In this way, the first and second electrical elements 19, 20 may be brought into resistive contact by means of the shrinkage of the shrink film 18.

As used herein, an electrically resistive contact is a contact formed between the electrical elements 19, 20. Electrical resistance at the contact point generates heat in the region of contact.

The first and second electrical elements 19, 20 may be sufficiently flexible such that when the apparatus is in use, the shape and relative positions of the elements 19, 20 can be adjusted in order that the elements 19, 20 can be moved into resistive contact at any particular longitudinal position along their length. The flexibility of the elements 19, 20 may be dependent on the material from which the elements 19, 20 are composed, the diameter of the elements, and cross-sectional shape of the elements, etc.

In the embodiment shown, the first and second elements 19, 20 comprise rods of electrically conductive material, such as copper rods. The elements 19, 20 may extend from one end of the heater 3 to the other and may be for example approximately 0.5 mm in diameter.

Generally, the electrical elements 19, 20 are configured such that their shape and/or position can readily be adjusted by means of the constriction of the heat-shrink material 18. In the embodiment shown, the elements 19, 20 are composed of fine metallic rods, and as a result can readily be bent, curved, twisted, angled, or otherwise adjusted in their shape and position in response to the type and magnitude of force provided by constriction of the heat-shrink material 18. In some embodiments, the elements 19, 20 may not easily bend, and may, for example, be rigid and inflexible. The elements 19, 20 may, for example, be arranged to slide, pivot, rotate, or otherwise be arranged to be positionally adjustable by means of the constriction of the heat-shrink material 18.

The elements 19, 20 may be attached to the heat shrink material 18 by means of a thermoplastic adhesive and are arranged such that they are spaced apart from one another and thereby electrically isolated along their entire longitudinal length prior to shrinkage of the heat shrink material 18.

The first and second elements 19, 20 are electrically coupled to the energy source 2. The electrical coupling between one or both of the elements 19, 20 and the energy source 2 is controlled by means of a switch (not shown), which may be user-operable. For example, the switch may comprise a push-button or similar at the exterior of the apparatus 1 or may be puff-activated.

The apparatus 1 comprises a heating element 26 by means of which the heater 3 may be activated. In the embodiment shown, at one end of the heater assembly 17, the first electrical element 19 is connected to the second electrical element 20 by a section of fuse wire 26, which is also in contact with the shrink film 18. The heating element 26 may comprise any material that emits thermal energy at a temperature exceeding the shrink temperature of the heat-shrink material 18 when supplied with an electrical current. For example, in the embodiment shown, the heating element 26 comprises a fuse wire that melts at a temperature exceeding the shrink temperature of the shrink film 18, such as between about 200° C. and 350° C., and heats to this temperature when carrying a particular value of electrical current matching or exceeded by that provided by the energy source 2.

The heater 3 is activated by engaging the switch which causes a current to pass along the fuse wire 26 between the first and second electrical elements 19, 20. The electrical current causes the fuse wire 26 to melt, for example causing it to blow, and release thermal energy. The fuse wire 26 is in contact with the heat-shrink tubing 18, and at the melting temperature of the fuse wire 26 the heat-shrink material 18 constricts. Constriction of the heat-shrink material 18 brings the electrical elements 19, 20 into resistive contact as described in more detail below.

In other embodiments, any other type of heating element 26 can be used. The heating element 26 may comprise a sacrificial overload device, which may be the fuse wire referred to above. Sacrificial devices other than a fuse wire may alternatively be used. In general, the sacrificial overload device is arranged such that when supplied with a predetermined electrical current the device heats to a temperature exceeding the shrink temperature of the shrink film 18. The heating element 26 may be destroyed in the process of heating the heat-shrink material 18 to the shrink temperature. For example, when the heating element 26 is a fuse wire, the heating element 26 may melt. Alternatively, the heating element 26 may not be destroyed.

In some embodiments, there may be no sacrificial overload device. For example, in such embodiments, the ends of the electrical elements 19, 20 at the first end of the heater 3 (away from the mouth end) may be arranged such that they are in resistive contact. In some embodiments, the heating element 26 may comprise a pre-constricted section of heat-shrink material 18, wherein by virtue of the pre-constricted heat-shrink material 18, sections of the electrical elements 19, 20 are in resistive contact. In these embodiments, the electrical elements 19, 20, being in resistive contact, generate heat at the point of contact, which initiate the constriction or further constriction of the heat-shrink material. In some embodiments, the tips of the electrical elements 19, 20 may be both in resistive contact and also connected by means of a heating element 26 such as a fuse wire.

The heater 3 in use at a first time point is shown in FIG. 3B, and in use at a second time point is shown in FIG. 3C, wherein the second time point is later than the first time point. In region (i), the first and second electrical elements 19, 20 are in resistive contact, and the electrical current passing between the electrical elements 19, 20 generates heat in the region of contact 21. The heat generated in the region of contact 21 causes the heat-shrink tube 18 in the adjacent region (ii) to shrink and constrict. Constriction of the heat-shrink tube 18 in region (ii) adjusts the shape and relative positions of the electrical elements 19, 20, forming a new region of resistive contact 21′ between the elements 19, 20. The constriction of the heat-shrink tube 18 thereby continues, gradually constricting the heat-shrink tube 18 from one end of the heater 3 to the other, and thus gradually forming new regions of resistive contact between the electrical elements 19, 20 from one end of the heater 3 to the other. The position of heat-generating resistive contact between the elements 19, 20, thus migrates, preferably at a substantially constant rate along the entire length of the heater 3.

By this arrangement, the heater 3 provides heat in a narrow circumferential band around the heater 3, in a position substantially corresponding to the position of resistive contact between the electrical elements 19, 20. Because heating occurs only at the point of resistive contact 21, 21′ between the electrical elements 19, 20, the circumferential band of heat provided by heater 3 is relatively narrow. That is, only a relatively small portion of the longitudinal length of the heater 3 is at an elevated temperature at any given time. The area of elevated temperature is small in comparison to the total surface area of the heater 3, and may be, for example, 10%, 20% or 40% of the total surface area of the heater 3. The circumferential band of heat provided by the heater 3 is hereinafter referred to as the “heating zone”.

The width of the heating zone (that is, the longitudinal extension of the heating zone along the heater 3) may in general be influenced by a number of factors. For example, the capacity of the heat-shrink material 18 to conduct heat, the rate of migration of the heating zone, the current provided by the energy source 2, and the nature of the resistive contact between the electrical elements 19, 20, may all be contributing factors. In general, the heating zone may be between approximately 1 mm and 2 cm wide.

The rate at which the heating zone migrates may also be influenced by a number of factors. For example, different heat-shrink materials may shrink at different rates and at different temperatures. The thickness of the heat-shrink material 18 may also be important, wherein the rate of migration of the heating zone may occur more slowly in thicker heat-shrink materials. The current provided by the energy source 2 may also be important, wherein the greater the current, the greater the rate of migration. The heat-shrink material 18 may constrict along its length at a rate of between approximately 5 mm and 30 mm every 60 seconds, thereby providing migration of the heating zone at a corresponding rate.

The process continues until the heat-shrink material 18 has been constricted along the entire length of the heater 3, or until the supply of electrical current is terminated. The apparatus 1 may comprise an arrangement by which the electrical current is terminated once the heat-shrink material 18 has been completely constricted.

In some embodiments, once the electrical supply is disconnected, it may be necessary to provide a replacement heating element 26 in order to restart the constriction process. In these embodiments, once switched off, if the apparatus 1 is to be reused, the heater assembly 17 may be replaced in order to supply the replacement fuse wire 26.

In other embodiments, the constriction process may be restarted even in the absence of a heating element 26 between the electrical elements 19, 20. In these embodiments, the resistive contact between the electrical elements 19,20 may be sufficient to restart the process.

In use, the apparatus 1 provides volatilized smokeable material compounds for inhalation by the user via the mouthpiece 6.

To use the apparatus 1, the user activates the heater 3 as described above using the switch. As shown in FIG. 1 and discussed above, the heater 3 may be located in a central region of the housing 7, and the heating chamber 4 and smokeable material 5 may be located around the longitudinal surface of the heater 3. However, a reverse arrangement, in which the heater 3 comprises a hollow cylinder located around the circumferential surface of a solid cylinder of smokeable material 5, is equally possible. In either arrangement, in use, thermal energy emitted by the heater 3 travels in a radial direction outwards or inwards respectively from the longitudinal surface of the heater 3 into the heating chamber 4 and the smokeable material 5.

The heater 3 is arranged so that the heating zone produced by the heater 3 migrates towards the second, mouth end 9 of the apparatus 1.

Because the heater 3 provides a narrow circumferential heating zone, it supplies thermal energy to the smokeable material 5 located radially adjacent to that region of the heater 3 without substantially heating the remainder of the smokeable material 5. The heated section of smokeable material 5 may comprise a section, such as a ring or disk, of smokeable material 5 which lies directly circumferentially adjacent to the heating zone produced by the heater 3. In this way, a small distinct section of the smokeable material 5 can be heated individually. The section of smokeable material 5 that is heated has a mass and volume which is significantly less than the body of smokeable material 5 as a whole. Furthermore, since the heating zone produced by the heater 3 migrates along the longitudinal length of the heater 3, the specific section of smokeable material 5 being heated also migrates along the length of the smokeable material 5, and the precise section of smokeable material 5 that is being heated is continually changing.

If the smokeable material 5 comprises tobacco for example, a suitable temperature for volatilizing the nicotine and other aromatic compounds may be above 120° C., such between 150° C. and 250° C. or between 130° C. and 180° C. Therefore, examples of temperatures in the heating zone include 150° C., 180° C., and 250° C.

The region of the heater 3 that is immediately in-front of the heating zone, into which the heating zone is progressing as the progressive shrinking of the heat shrink material 18 continues, may be pre-heated by longitudinal thermal conduction from the heating zone. This region may comprise a pre-volatilizing region of the heater 3, which heats up the smokeable material 5 in preparation for its components to be volatilized by the approaching heating zone. This pre-heating does not heat the smokeable material 5 to a sufficient temperature to volatilize nicotine or other volatilizable material. A suitable temperature could be less than 120° C., such as approximately 100° C.

Once the heater 3 has been activated, the smokeable material 5 is heated and the user may obtain volatilized smokeable material compounds by drawing on the mouthpiece 6 of the apparatus 1. As the user draws on the mouthpiece 6, air is drawn into the heating chamber 4 of the apparatus 1 via the air conduits 14 and the valves 15. As it is drawn through the heated smokeable material 5 in the heating chamber 4, the air is enriched with smokeable material vapours, such as aroma vapours, before being inhaled by the user at the mouthpiece 6. Between draws, the valves 15 may close so that all volatilized substances remain contained inside the chamber 4 pending the next draw. The partial pressure of the volatilized substances between puffs approaches the saturated vapour pressure and the amount of evaporated substances therefore depends largely on the temperature in the heating chamber 4. This helps to ensure that the delivery of volatilized nicotine and aromatic compounds remains constant throughout the use of the smoking article. The valve 15 may open as the user draws on the mouthpiece 6 so that gaseous flow may be drawn through the heating chamber 4 to carry volatilized smokeable material components to the user via the mouthpiece 6. In some embodiments, a membrane may be located in the valves 15 to ensure that no oxygen enters the chamber 4. The valves 15 may be breath-actuated so that they open when the user draws on the mouthpiece 6. The valves 15 may close when the user stops drawing. Alternatively, the valves 15 may, for example, close following the elapse of a predetermined period after their opening. Optionally, a mechanical or other suitable opening/closing arrangement may be present so that the valves 15 open and close automatically.

In general, in apparatus of the type described herein, the length of the housing 7 may be approximately 130 mm, the length of the energy source may be approximately 59 mm, and the length of the heater 3 and heating region 4 may be approximately 50 mm. Other embodiments may have different dimensions. The diameter of the housing 7 may be between approximately 15 mm and approximately 18 mm. For example, the diameter of the housing's first end 8 may be 18 mm whilst the diameter of the mouthpiece 6 at the housing's second end 9 may be 15 mm. The depth of the heating chamber 4 may be approximately 5 mm and the heating chamber 4 may have an exterior diameter of approximately 10 mm at its outwardly-facing surface. The diameter of the energy source 2 may be between approximately 14 mm and approximately 15 mm, such as 14.6 mm.

In the embodiment shown in FIGS. 1 to 3, the diameter of the heater 3 may be between approximately 2 mm and approximately 6 mm. The diameter of the heater 3 may, for example, be between approximately 4 mm and approximately 4.5 mm or between approximately 2 mm and approximately 3 mm. Heater diameters outside these ranges may alternatively be used.

In other embodiments, the apparatus may comprise different heater arrangements, which heaters nevertheless work in accordance with the same principle and offer the same advantages as those relating to the embodiments described above.

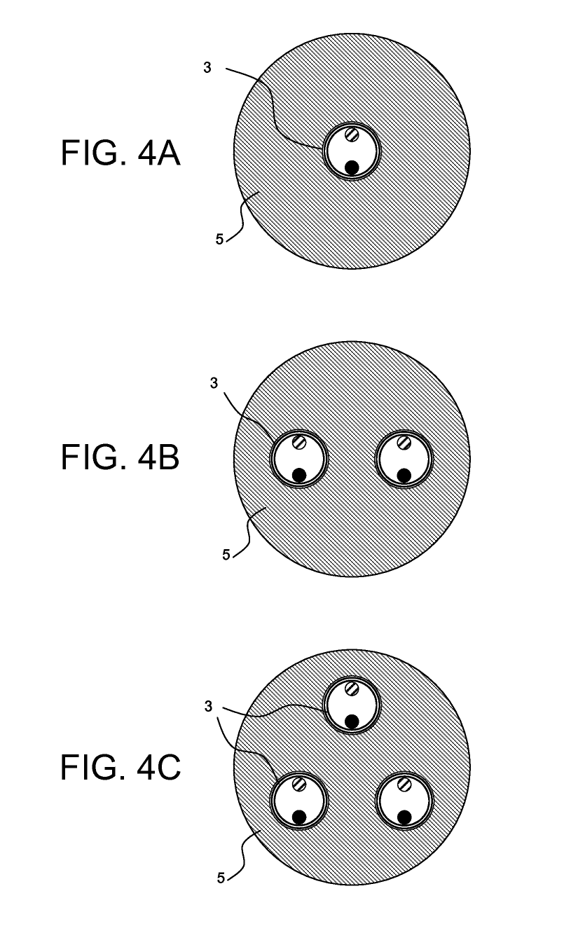

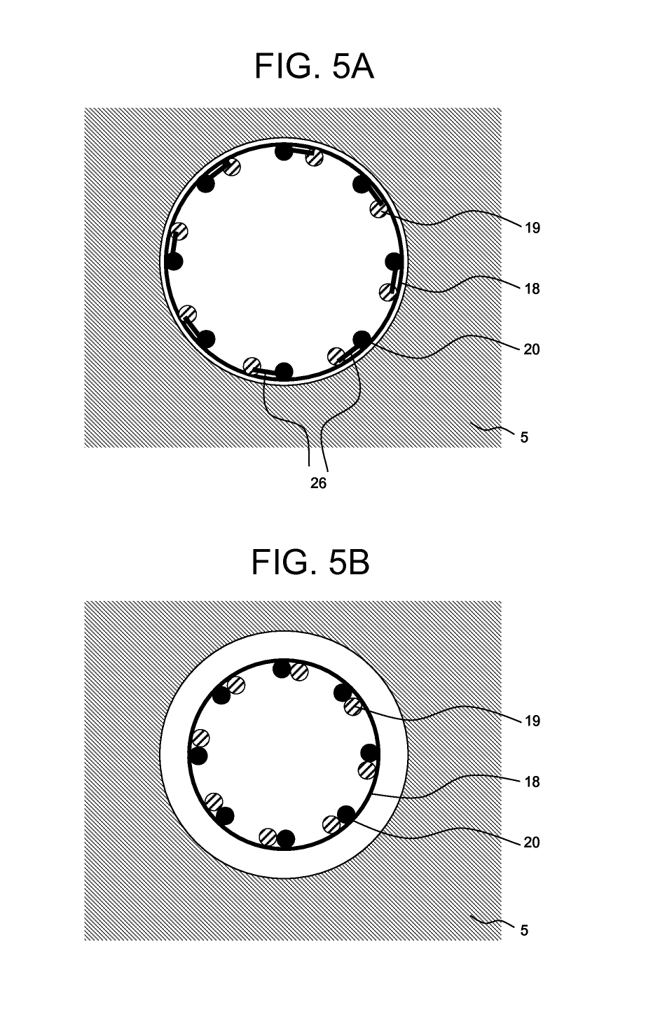

In some embodiments, for example, the apparatus 1 may comprise a plurality of heaters 3 of the type described above in respect of the embodiment shown in FIGS. 1 to 3. Example embodiments are shown in FIGS. 4B and 4C. For comparison, FIG. 4A is a diagram showing the arrangement of the smokeable material 5 and the heater 3 of the embodiment shown in FIGS. 1 to 3. As described above, in this embodiment, the heater 3 is positioned in the centre of the smokeable material 5. FIGS. 4B and 4C show related embodiments in which the apparatus 1 comprises two and three heaters 3, respectively. In other embodiments, the apparatus may comprise any suitable number of heaters 3, such as four, five, six, eight, ten, twelve, or more heaters. The plurality of heaters 3 may have any arrangement within the smokeable material 5. In the embodiments shown in FIGS. 4B and 4C, the heaters 3 are positioned within the smokeable material 5 such that they are evenly spaced in order to most efficiently heat the smokeable material 5. In embodiments comprising a plurality of heaters 3, the same considerations regarding the arrangement of smokeable material 5 apply as described above in respect of the embodiment of FIG. 1. In particular, the smokeable material 5 should fit within the heating chamber 4 in a suitable manner to efficiently receive thermal energy from the heaters 3.

In some embodiments in which the apparatus 1 comprises a plurality of heaters 3, the heaters 3 are generally arranged such that the narrow circumferential heating zone produced by each heater 3 migrates along the heater 3 at substantially the same rate, so that a narrow section of the smokeable material 5 is heated. In other embodiments, however, the heating zones of the different heaters 3 may migrate at different rates. For example, the apparatus 1 may be provided with a heating zone which progresses at a faster rate than the other heating zones so as to provide the pre-heating effect referred to previously.

In some embodiments the arrangement of the components within the heater 3 may be different to that described above and shown in FIGS. 3 and 4.

For example, in the embodiment shown in FIG. 5, the heater assembly 17 comprises a plurality of first electrical elements 19 and a plurality of second electrical elements 20, adhered to the inner wall of a heat-shrink tube 18. The first and second electrical elements 19, 20 comprise rods of electrically conductive material, such as copper rods, which extend from one end of the heater 3 to the other.

Prior to use, all of the electrical elements 19, 20 are separated and thus electrically isolated. For example, the elements 19, 20 may be adhered to the inner wall of the heat shrink tube 18 in locations at which they are physically separated from one another. Each of the first electrical elements 19 is connected to one of the second electrical elements 20 by a heating element 26, which in the embodiment shown is a short length of fuse wire 26, to form a number of electrical element pairs. Each of the fuse wires 26 is in close contact with the heat-shrink tube 18.

As described above, the heater 3 is activated by passing a current through the fuse wires 26 between each of the paired first and second electrical elements 19, 20. The current overloads the fuse wire 26 connecting each element pair, causing the fuse wire 26 to melt and release thermal energy. Because the fuse wires 26 are in contact with the heat-shrink tube 18, the melting of the fuse wires 26 causes the heat-shrink tube 18 to constrict in the vicinity of the fuse wires 26. Constriction of the heat shrink tube 18 adjusts the position of the electrical elements 19, 20, bringing elements of opposite polarity into resistive contact, as shown in FIG. 5B. In a manner analogous to that described above in respect of the embodiment of FIGS. 1 to 3, a heating zone is thus established which migrates along the length of the heater 3. In the embodiment of FIG. 5, the heating zone is formed by electrically resistive contacts formed between the first and second electrical elements 19, 20 within each of the element pairs.

In general, any suitable arrangement of heat-shrink material 18 may be used wherein shrinkage of the heat-shrink material 18 results in a resistive contact being formed between a plurality of electrical elements.

In some embodiments, the resulting resistive contact may cause further shrinkage of the heat-shrink material 18.

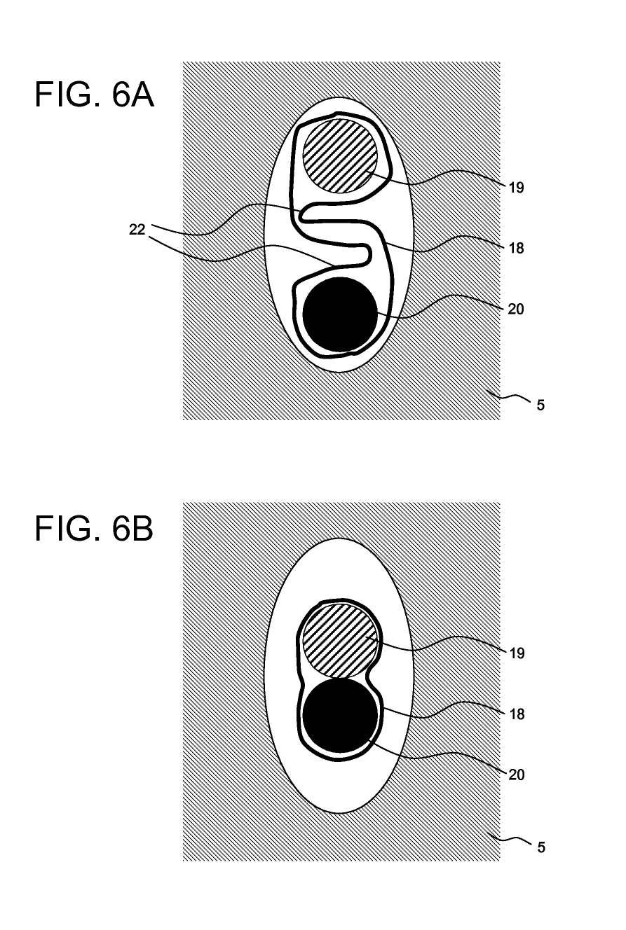

In further embodiments, prior to shrinkage, the heat-shrink material 18 may be arranged to function as an electrical insulator between a plurality of electrical elements 19, 20, preventing the passage of an electrical current between the elements 19, 20 prior to activation of the heater 3. In some of these embodiments, the subsequent constriction of the heat-shrink material 18 causes the formation of a resistive contact between the plurality of elements 19, 20. An example of this type of embodiment is shown in FIG. 6.

The heater 3 shown in FIG. 6A is similar to that described above in respect of the embodiment shown in FIGS. 1 to 3. However, as shown in FIG. 6A, the heat-shrink tube of this example comprises a number of folds 22 which are gathered between the electrical elements 19, 20.

Prior to use, the folds 22 form an electrically insulating barrier between the two elements 19, 20.

When the heater 3 is activated, the heat-shrink tube 18 is heated and caused to constrict. For example, heating and constriction of the heat-shrink material 18 may be initiated by means of a heating element (not shown), such as a section of fuse wire connecting the first electrical element 19 to the second electrical element 20, as described above.

As shown in FIG. 6B, constriction of the heat-shrink tube 18 has the dual effect of both removing the folds 22, which previously formed an insulating barrier, and moving the electrical elements 19, 20 into a position in which they are in resistive contact.

As described above, resistive contact between the electrical elements 19, 20 generates heat and causes further shrinkage of the heat-shrink tube 18. A heating zone is thus established which migrates along the length of the heater 3, as described above.

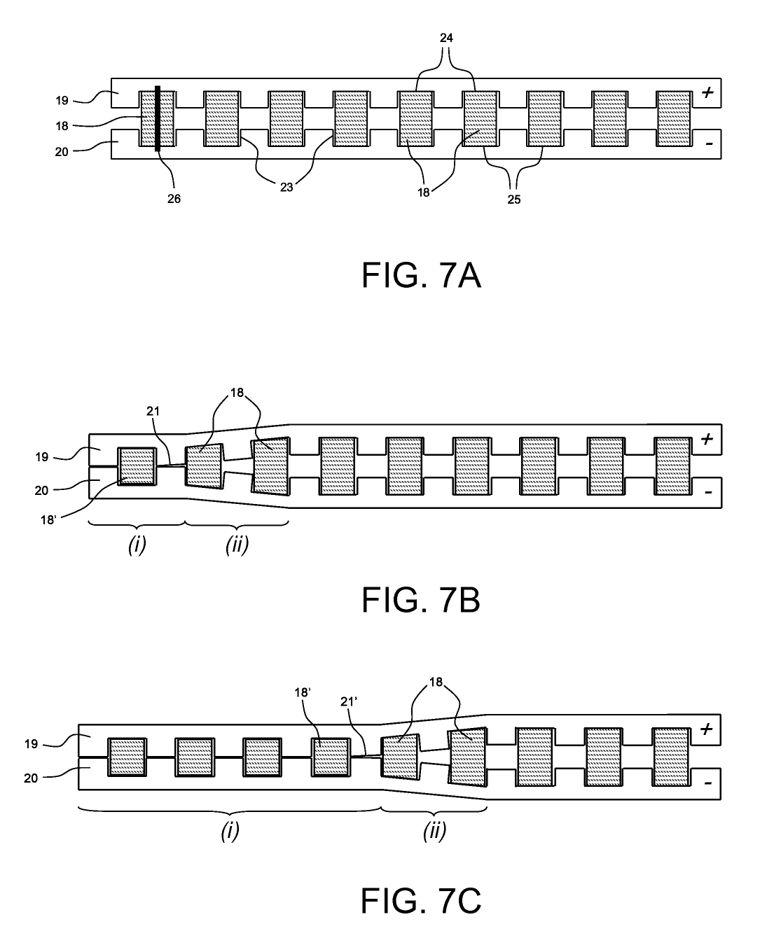

Another embodiment in which, prior to use, the heat-shrink material functions to maintain electrical isolation of the plurality of electrical elements is shown in FIG. 7.

As shown in FIG. 7A, the first and second electrical elements 19, 20, are adhered to a plurality of sections of heat-shrink material 18. The sections of heat-shrink material 18 are positioned between the first and second electrical elements 19, 20 and the sections of heat-shrink material 18 thereby maintain the separation and electrical isolation of the elements 19, 20.

The elements 19, 20 are shaped to receive the sections of heat-shrink material 18 within a plurality of recesses 23, wherein each recess 23 is shaped to receive a section of heat-shrink material 18. The sections of heat-shrink material 18 are adhered to the bases of the recesses 23 by a thermoplastic adhesive.

In the position of the recesses, the elements 19, 20 may have a reduced width and may as a result have an increased flexibility, and may be more readily bent, in these positions.

As shown in FIG. 7A, the sections of heat-shrink material 18 are substantially in the form of a rectangular prism or cuboid. A first end 24 of each section of heat shrink material 18 is adhered to the first electrical element 19, and a second end 25 of each section of heat shrink material 18 is adhered to the second electrical element 20. By means of the sections of heat-shrink material 18, the separation and electrical isolation of the elements 19, 20 may be maintained.

The heater 3 comprises an ignition mechanism in the form of a heating element 26, as described above in relation to other embodiments. In the embodiment shown, at one end of the heater 3, the first electrical element 19 is connected to the second electrical element 20 by a section of fuse wire 26, which is also in contact with the first section of heat-shrink material 18. The fuse wire 26 may be replaced by any material or device that becomes heated to a temperature exceeding the shrink temperature of the heat-shrink material 18 when supplied with an electrical current. In this embodiment, the shrink temperature may be for example between about 50° C. and 150° C.

The heater 3 is activated by passing a current between the first and second electrical elements 19, 20. The current causes the fuse wire 26 to melt and release thermal energy. Because the fuse wire 26 is in contact with the heat-shrink material 18, the heat-shrink material 18 constricts when the fuse wire 26 is heated.

When one of the sections of heat-shrink material 18 constricts, the shape of the elements 19, 20 is altered such that resistive contact is made between the elements 19, 20 adjacent to the constricted section of heat shrink material 18′.

The heater 3 in use at a first time point is shown in FIG. 7B, and in use at a second time point is shown in FIG. 7C, wherein the first time point is earlier than the second time point. In region (i), the first and second electrical elements 19, 20 are in resistive contact, and the electrical current passing between the elements 19, 20 in this region generates heat in the region of contact 21. The heat generated in the region of contact 21 causes the sections of heat-shrink material 18 in the adjacent region (ii) to shrink. Shrinkage of the sections of heat-shrink material 18 in region (ii) adjusts the shape and relative positions of the elements 19, 20, causing them to bend at positions corresponding to the adjacent recesses 23, and thereby forming a new region of resistive contact 21′ between the elements 19, 20. The shrinkage of the sections of heat-shrink material 18 thereby continues progressively from one end of the heating apparatus 17 to the other, thus progressively forming new regions of resistive contact between the elements 19, 20 from one end of the heater 3 to the other. The position of heat-generating resistive contact between the elements 19, 20, thus migrates along the entire length of the heater 3.

A heating zone is thus established which migrates along the length of the heater 3 as described above in respect of other heater assembly embodiments.

In some embodiments, as referred to above, the apparatus 1 may comprise a heater 3 which extends circumferentially around the outside of the smokeable material 5. In particular, the heater 3 may comprise a substantially elongate tube, which may be cylindrical, wherein the heating chamber 4 is located inside the hollow centre of the tube 3 rather than around the heater's outer circumference. In such embodiments, the locations of the smokeable material 5 and heater 3 shown in FIGS. 1 and 2 would be reversed.

For example, the circumferential heater may comprise a plurality of heaters 3 of the type described above, for example in relation to the embodiment of FIGS. 1 to 3. The plurality of heaters 3 may extend longitudinally along the length of the heating chamber 4 and may be circumferentially arranged around the heating chamber 4. The heaters 3 may be generally arranged such that the heating zone produced by each heater 3 migrates along the heater 3 at the same rate, so that a only narrow section of the smokeable material 5 is heated.

The heater 3 may in some embodiments be positioned within a container, such as a gas-impermeable container. The container may in some embodiments comprise a vent or one-way valve to allow any gases produced by the heater 3 to escape from the container. However, the valve is generally not in fluid communication with the smokeable material 5 or mouthpiece 6 so that any gases emitted by the heater 3 cannot dilute the aromatic compounds and nicotine if present released from the smokeable material 5, and cannot be inhaled by the user.

In general, the plurality of electrical elements 19, 20 may comprise any electrically conductive material, such as copper for example. The electrical elements 19, 20 may comprise the same or different materials.

Although the heating element 26 has predominately been described as a fuse wire 26, it will be appreciated that any of the embodiments may employ an alternative heating element to initiate carbonisation of the insulating material 21.

The mass of the smokeable material 5 which is heated by the heater 3 may be in the range of 0.2 to 1 g. The temperature to which the smokeable material 5 is heated may be user controllable, for example to any temperature within the temperature range of 120° C. to 250° C. as previously described. The temperature to which the smokeable material 5 is heated to volatilize components of the smokeable material 5 may be, for example, any temperature within the temperature range of 120° C. to 250° C. as previously described. The mass of the apparatus 1 as a whole may be in the range of 70 to 125 g, although a smaller mass is also possible. An example battery 2 has a capacity of 1000 to 3000 mAh and a voltage of 3.7V.

In some embodiments, the smokeable material 5 may be comprised in a cartridge which can be inserted into the heating chamber. The smokeable material cartridge fits around or inside the heater 3, depending on its type, so that the internal/external surface of the smokeable material tube 5 faces the external/internal longitudinal surface of the heater 3. The cartridge is a close fit with the heater 3 to ensure efficient heat transfer. The cartridge 5 is generally not longer than the heater 3 and may be approximately equal to the length of the heater 3 so that the heater 3 can heat the smokeable material 5 along its entire length.

In some embodiments, the thermal insulation 11 may be provided as part of the smokeable material cartridge 5, located co-axially around the outside of the smokeable material 5.

An advantage of the apparatus 1, and in particular the heater 3, is that there is no requirement for a dedicated control system to regulate the heating of the smokeable material 5, and/or to adjust the section of smokeable material that is being heated. Instead, once the disclosed apparatus is activated, a small section of the smokeable material 5 is heated and the area of heating migrates at a substantially constant rate from one end of the smokeable material 5 to the other. Furthermore, the degree of heat and the rate of migration can easily be controlled and predetermined by adjusting the composition and arrangement of the heater 3.

A further advantage of this arrangement is that activating only a small portion of the heater 3 means that the energy required to heat the smokeable material 5 is reduced in comparison to that required to heat the full amount of smokeable material over the entire period of use of the article 1.

A further advantage is that once activated the apparatus is permanently ready and able to provide smokeable material components to the user because the smokeable material is continually being heated. This allows the aromatics, and nicotine if present, to be inhaled by the user without substantial delay, for example, whilst a heater is activated to heat the smokeable material in response to detection of the user drawing on the apparatus.

It will be appreciated that any of the alternatives described above can be used singly or in combination. For example, as previously described, the heater 3, or a plurality of heaters 3, may be located around the outside of the smokeable material 5 rather than the smokeable material 5 being located around the heater 3. The heater 3 may therefore circumscribe the smokeable material 5 to apply heat to the smokeable material 5 in a substantially radially inward direction.

In order to address various issues and advance the art, the entirety of this disclosure shows by way of illustration and example various embodiments in which the claimed invention may be practised and which provide for a superior apparatus arranged to heat but not burn smokable material. The advantages and features of the disclosure are of a representative sample of embodiments only, and are not exhaustive and/or exclusive. They are presented only to assist in understanding and teach the claimed and otherwise disclosed features. It is to be understood that advantages, embodiments, examples, functions, features, structures and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist in essence of, various combinations of the disclosed elements, components, features, parts, steps, means, etc. The disclosure may include other inventions not presently claimed, but which may be claimed in future.

1. An apparatus configured to heat smokeable material to volatilize at least one component of the smokeable material, wherein the apparatus comprises a heater comprising a heat-shrink material, and wherein the heater is configured to progressively heat the smokeable material upon constriction of the heat-shrink material.

2. The apparatus according to claim 1, wherein the heater is configured to trigger constriction of the heat-shrink material.

3. The apparatus according to claim 1, wherein the heater is configured to trigger constriction of the heat-shrink material in response to a user action.

4. The apparatus according to claim 1, wherein the heater is configured to trigger constriction of the heat-shrink material by heating the heat-shrink material to a shrink temperature of the heat-shrink material.

5. The apparatus according to claim 1, wherein the heater comprises a heating element arranged to trigger constriction of the heat-shrink material by heating the heat-shrink material to the shrink temperature.

6. The apparatus according to claim 1, wherein the heater is configured to progressively constrict the heat-shrink material along the heater to cause progressive heating of the smokeable material.

7. The apparatus according to claim 1, wherein the heater comprises a plurality of electrical elements, and wherein the heater is configured to form an electrically resistive contact between the elements upon constriction of a portion of the heat-shrink material.

8. The apparatus according to claim 7, wherein the electrically resistive contact is configured to supply heat to the smokeable material and also to cause constriction of a further portion of the heat-shrink material.

9. The apparatus according to claim 7, wherein prior to constriction of the heat-shrink material, the elements are electrically isolated from one another by the heat-shrink material.

10. The apparatus according to claim 7, wherein the heater is configured to alter the position and/or shape of one or more of the elements by means of the constriction of the heat-shrink material.

11. The apparatus according to claim 7, wherein the heater is configured to cause the position of the electrically resistive contact to migrate progressively from a first end of the heater to a second end of the heater.

12. The apparatus according to claim 1, wherein the heat-shrink material comprises polyolefin.

13. The apparatus according to claim 1, wherein the apparatus is configured to heat the smokeable material without combusting the smokeable material.

14. The apparatus according to claim 1, wherein the heat-shrink material comprises PTFE.

15. The apparatus according to claim 1, wherein the heat-shrink material comprises Viton.
